(19) United States
(12) Patent Application Publication
(10) Pub. No.: US 2024/0256826 A1
(43) Pub. Date: Aug. 1, 2024

(54) DESIGN METHOD AND RECORDING MEDIUM

(71) Applicant: NEC Corporation, Minato-ku, Tokyo (JP)

(72) Inventor: Yusuke SAKEMI, Tokyo (JP)

(73) Assignee: NEC Corporation, Minato-ku, Tokyo (JP)

(21) Appl. No.: 18/561,041

(22) PCT Filed: May 26, 2021
(86) PCT No.: PCT/JP2021/019903

§ 371 Date: Nov. 15, 2023

(51) Int. Cl. G06N 3/04; G06N 3/063; G06N 3/08

(52) U.S. Cl. CPC G06N 3/04; G06N 3/063; G06N 3/08

(57) ABSTRACT

A design method includes determining at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

### TECHNICAL FIELD

The present invention relates to a design method and a recording medium.

### BACKGROUND ART

One type of neural network is the spiking neural network (SNN) (see, for example, Patent Document 1). Spiking neural networks are expected to be power efficient neural networks in that they use binary signals called spikes to transfer information between spiking neurons.

### PRIOR ART DOCUMENTS

### Patent Documents

Patent Document 1: PCT International Publication No. WO 2020/241365

### SUMMARY OF INVENTION

### Problems to be Solved by the Invention

In hardware implementations of spiking neurons, circuits with discretized firing times may be more advantageous in terms of ease of manufacture and power efficiency. On the other hand, in general, models with discretized time tend to be less accurate in learning.

An example of an object of the present invention is to provide a design method and a recording medium that can solve the above-mentioned problems.

### Means for Solving the Problem

According to the first example aspect of the present invention, the design method comprises determining at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

According to the second example aspect of the present invention, the recording medium records a program for causing a computer to determine at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

### Effects of Invention

According to the present invention, the firing time can be discretized and the learning accuracy is relatively high.

### BRIEF DESCRIPTION OF THE DRAWINGS

FIG. 1 is a diagram that illustrates an example of a mathematical model of a spiking neuron subject to discretization according to the example embodiment.

FIG. 2 is a diagram that illustrates an example of the time evolution of the membrane potential of a spiking neuron.

FIG. 3 is a diagram that illustrates an example of a circuit model of a spiking neuron.

FIG. 4 is a diagram that illustrates an example of the firing time in a spiking neural network.

FIG. 5 is a diagram that illustrates an example of the processing procedure in the design method according to the example embodiment.

FIG. 6 is a flowchart that illustrates an example of processing in the design method according to the example embodiment.

FIG. 7 is a schematic block diagram that illustrates the configuration of a computer according to at least one example embodiment.

### EXAMPLE EMBODIMENT

The following is a description of example embodiments of the present invention, however, these example embodiments are not intended to limit the scope of the invention as claimed. Not all of the combinations of features described in the example embodiments are essential to the solution of the invention.

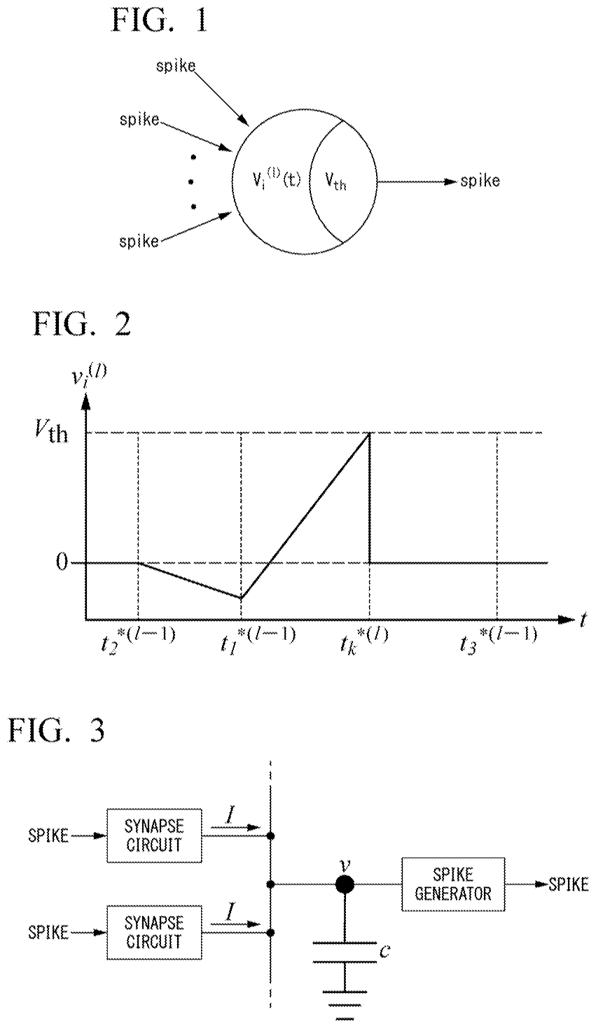

FIG. 1 is a diagram that illustrates an example of a mathematical model of a spiking neuron subject to discretization.

In a spiking neuron, an internal state called a membrane potential evolves over time in response to spike inputs. In FIG. 1, the membrane potential is denoted as vᵢ⁽¹⁾(t). In FIG. 1, a hierarchical neural network is assumed, with the i-th spiking neuron in layer 1 shown. However, the structure of a spiking neural network is not limited to a hierarchical structure.

When the membrane potential vᵢ⁽¹⁾(t) reaches the firing threshold Vₜₕ, the spiking neuron outputs a spike.

FIG. 2 shows an example of the temporal evolution of the membrane potential of a spiking neuron. The horizontal axis of the graph in FIG. 2 indicates time. The vertical axis indicates membrane potential. In FIG. 2, the membrane potential is denoted as vᵢ⁽¹⁾.

The spiking neuron in FIG. 2 receive spike inputs from spiking neurons in layer 1-1 at times t₂*⁽¹⁻¹⁾, t₁*⁽¹⁻¹⁾, and t₃*⁽¹⁻¹⁾, respectively. After the input of a spike, the membrane potential continues to change at a rate of change corresponding to the weighting set for each spiking neuron from which the spike output originates. The rate of change of the membrane potential for each spike input is linearly additive.

At time tₖ*⁽¹⁾, the membrane potential of the spiking neuron in FIG. 2 reaches the firing threshold Vₜₕ, and the spiking neuron fires. Ignition causes the membrane potential to go to zero, after which the membrane potential remains unchanged despite the input of spikes.

The time at which a spiking neuron fires is referred to as the firing time. The firing time is also referred to as the spike time.

In the following description, it is also assumed that the firing time, the spike output time of the spiking neuron on the spike output side, and the spike input time of the spiking neuron on the spike input side are the same. However, there may be a non-negligible delay between the spike output time of the spiking neuron on the spike output side and the spike input time of the spiking neuron on the spike input side. In such cases, the delay time may be indicated in the equation.

The membrane potential after firing is not limited to those that do not change from the potential 0 described above. For example, after a predetermined time after firing, the membrane potential may change in response to the spike input.

The change in membrane potential before firing in the mathematical model of a spiking neuron can be shown as the differential equation in Equation (1).

$$\begin{matrix}[ Equation 1 ] & \\ \frac{d}{dt} {v}_{i}^{( l )} ( t ) = {\sum }_{j} {w}_{i j}^{( l )} θ ( t - {t}_{j}^{* ( l - 1 )} ) & ( 1 )\end{matrix}$$

vᵢ⁽¹⁾(t) denotes the membrane potential of the i-th spiking neuron in layer 1 at time t.

wᵢⱼ⁽¹⁾ represents the weighting for spikes from the j-th spiking neuron in layer 1-1 to the i-th spiking neuron in layer 1.

θ represents the step function and is shown in Equation (2).

$$\begin{matrix}[ Equation 2 ] & \\ θ ( x ) = \{ \begin{matrix}0 , ( x < 0 ) \\ 1 , ( x \geq 0 )\end{matrix} & ( 2 )\end{matrix}$$

tⱼ*⁽¹⁻¹⁾ indicates the firing time of the j-th spiking neuron in layer 1-1.

Consider a hardware implementation of the mathematical model of a spiking neuron described above.

The mathematical model of a spiking neuron subject to the design method for the example embodiment is not limited to the one shown in Equation (1). For example, it is equally possible to apply the design method of the example embodiment to a general leaky integrate-and-fire neuron.

FIG. 3 shows an example of a spiking neuron circuit model. The circuit model here is the circuit that implements the model.

In the circuit model of FIG. 3, when a pulse or step signal spike is input to the synapse circuit, the synapse circuit continues to output a weighted current.

The currents output by the synaptic circuit are summed and flow to the capacitor to be stored, creating a potential in the capacitor. The potential of this capacitor simulates the membrane potential.

A spike generator compares the capacitor potential to a predetermined firing threshold. When the capacitor potential reaches the firing threshold, the spike generator outputs a spike.

One spike generator may output a spike only once. Alternatively, a single spike generator can fire multiple times by resetting the capacitor potential when a spike occurs, etc.

The change in membrane potential before firing in the circuit model of the spiking neuron can be illustrated as in the differential equation in Equation (3).

$$\begin{matrix}[ Equation 3 ] & \\ C \frac{d}{dt} {v}_{i}^{( l )} ( t ) = {\sum }_{j} {I}_{ij}^{( l )} ( t ) & ( 3 )\end{matrix}$$

C indicates the capacitance of the capacitor.

Iᵢⱼ⁽¹⁾(t) represents the current value to simulate the change in membrane potential due to spiking from the j-th spiking neuron in layer 1-1 to the i-th spiking neuron in layer 1.

When the presence or absence of current is expressed using the step function 0 in Equation (2), Equation (3) is transformed as in Equation (4).

$$\begin{matrix}[ Equation 4 ] & \\ C \frac{d}{dt} {v}_{i}^{( l )} ( t ) = {\sum }_{j} {I}_{ij}^{( l )} θ ( t - {t}_{j}^{* ( l - 1 )} ) & ( 4 )\end{matrix}$$

Iᵢⱼ⁽¹⁾ represents the current value when the synaptic circuit outputs current. Since the switching of the current between ON and OFF is indicated by “θ(t-tⱼ*⁽¹⁻¹⁾),” the current value Iᵢⱼ⁽¹⁾ is treated as a constant whose value can be updated by learning. Therefore, unlike the case of Equation (3), in Equation (4), “(t)” is not added to “Iᵢⱼ⁽¹⁾”.

Consider discretizing the firing time by the spike generator and the weighting by the synaptic circuit in the configuration shown in FIG. 3. Circuits in which these are discretized may be more advantageous in terms of ease of manufacture and power efficiency. Discretization here is also referred to as quantization.

On the other hand, in general, models with discretized time tend to be less accurate in learning. The learning accuracy of spiking neurons may also be lower when trained on circuit models with discretized time.

In the mathematical model of a spiking neuron shown in Equation (1), if time is discretized and expressed in time steps, the membrane potential is shown in Equation (5).

$$\begin{matrix}[ Equation 5 ] & \\ {v}_{i}^{( l )} ( t ) = {v}_{i}^{( l )} ( t - 1 ) + {\sum }_{j} {w}_{ij}^{( l )} θ ( t - {t}_{j}^{* ( l - 1 )} ) & ( 5 )\end{matrix}$$

In Equation (5), time is expressed in time steps, and t takes integer values, for example, 0, 1, 2, . . . .

The membrane potential “vᵢ⁽¹⁾(t)” at time t is calculated by adding the change per unit time of the time step “Σⱼ(wᵢⱼ^{(1)θ(t-t}ⱼ*⁽¹⁻¹⁾))” to the membrane potential “vᵢ⁽¹⁾(t-1)” at time t-1.

The mathematical model shown in Equation (5), when implemented in the circuit model shown in FIG. 3, is shown in Equation (6).

$$\begin{matrix}[ Equation 6 ] & \\ {Cv}_{i}^{( l )} ( t ) = {Cv}_{i}^{( l )} ( t - 1 ) + {\sum }_{j} {I}_{ij}^{( l )} ( t ) & ( 6 )\end{matrix}$$

In Equation (6), Σⱼ(Iᵢⱼ⁽¹⁾(t)), which is the sum of the current values multiplied by the unit time “1,” indicates the amount of change in the capacitor charge from time t-1 to time t.

When training with a model in which time is discretized and represented in time steps, as in Equation (6), the accuracy of the training may be low.

It is also possible that the accuracy of the spiking neural network operations may vary depending on how much the unit time in the time step is in non-discretized time. The shorter the unit time range, the more accurate the calculation is expected to be.

On the other hand, when discretizing the firing time in the spike generator to match the increment of the firing time with the time width of the unit time in the time step, a shorter time width of the unit time requires a spike generator with a shorter increment of the firing time.

Thus, in this case, there is a tradeoff between the accuracy of the spiking neural network operations and the required specifications for the spike generator.

If the discretization of the firing time in the spike generator makes the increment of the firing time constant regardless of the time width of the unit time in the time step, a shorter time width of the unit time may result in a larger number of steps in the time step required for the calculation. A larger number of steps increases calculation time and power consumption.

Thus, in this case, the tradeoff is between the accuracy of the spiking neural network operation and the operation time and power consumption.

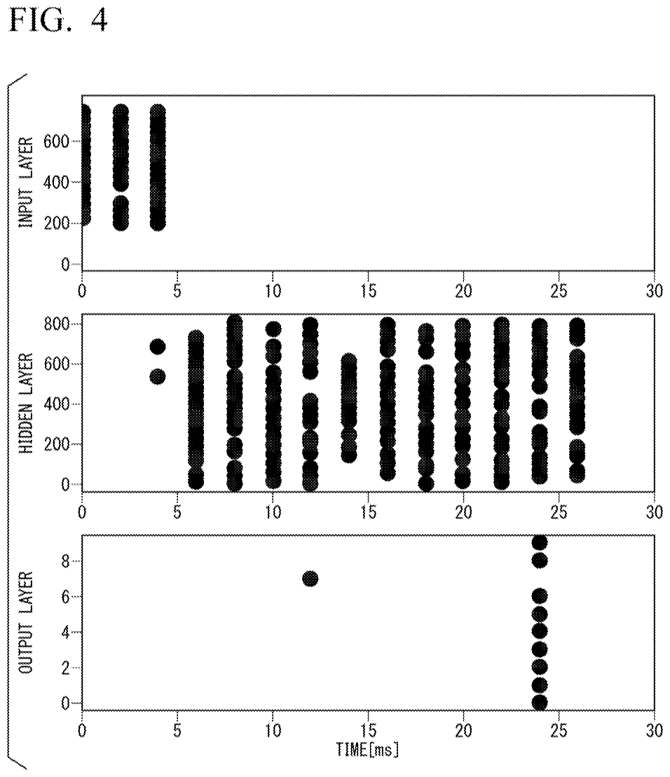

FIG. 4 shows an example of firing times in a spiking neural network. The horizontal axis of the graph in FIG. 4 shows time, which is the time elapsed since the first spiking neuron in the input layer fired. The unit of time on the horizontal axis is milliseconds (ms). The vertical axis shows the identification number of spiking neurons in the input, hidden, and output layers, respectively.

In the example in FIG. 4, time is expressed in time steps, with a unit time of 2 ms. Six steps after the spiking neuron in the input layer first fires, the spiking neuron in the output layer first fires.

Let us assume that the mathematical model in which time is discretized is configured with a time step unit time of 2 ms, as shown in FIG. 4, and the circuit model in which time is discretized is also configured with a spike generator firing time increment of 2 ms.

From this state, consider the case where the unit time for a time step in the mathematical model is 1 ms.

In this case, the spike generator in the circuit model could be replaced with one with a firing time increment of 1 ms. By replacing the spike generator, the circuit model can obtain the calculation results in the same amount of time as in the mathematical model.

On the other hand, it is burdensome to prepare spike generators with short firing time increments and to replace spike generators.

Alternatively, the spike generator in the circuit model with a firing time increment of 2 ms could be used as is. In this case, there is no need to provide a new spike generator or to replace the spike generator.

On the other hand, the incremental width of the firing time could be twice the unit time of the time step, so that the computation time in the circuit model is twice the operation time in the mathematical model. If the charge stored in the capacitor exceeds the capacitor's storage capacity due to longer operation times, the capacitor or synapse circuit will need to be replaced.

Thus, there are advantages and disadvantages with respect to the length of the time width of the unit time, both when the increment of the firing time of the spike generator is adjusted to the time width of the unit time in the time step, and when it is constant regardless of the time width of the unit time.

After training with a discretized circuit model, changing the time range of the unit time requires re-training, which is a burden on the person in charge of the training. Changing the time range of a unit of time after learning with a discretized mathematical model also requires relearning, which is a burden on the person in charge of learning.

Therefore, in the design method of the example embodiment, after training using a non-discretized mathematical model, the trained mathematical model is implemented in a circuit model in which the firing time by the spike generator and the weighting by the synaptic circuit are discretized.

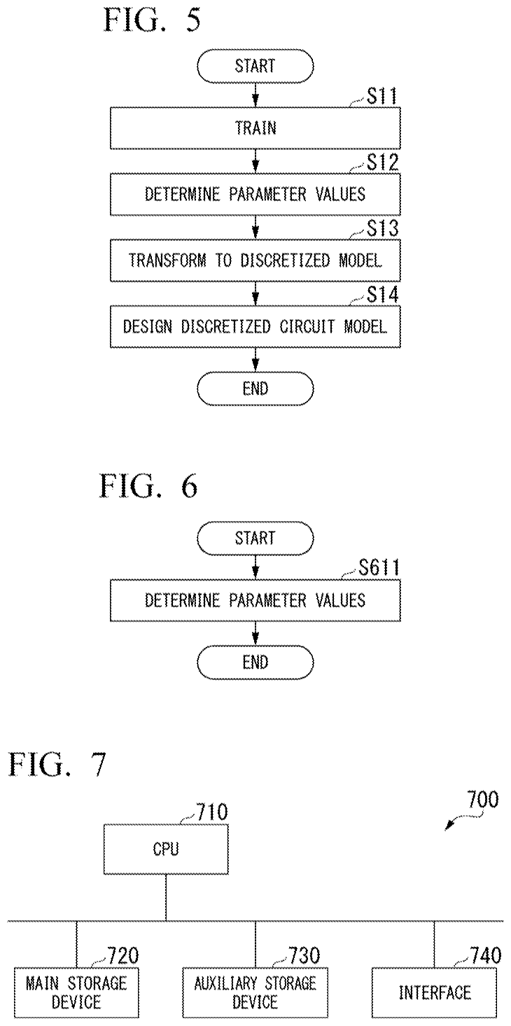

FIG. 5 shows an example of the processing steps in the design method. A computer or other device may automatically or semi-automatically perform the processing in FIG. 5. Alternatively, a person may perform the processing in FIG. 5, such as the designer of the spiking neural network using a computer to perform the processes in FIG. 5.

In the processing shown in FIG. 5, the device or person trains a non-discretized model of the spiking neural network (Step S11). Training of the model here means adjusting the parameter values of the model by machine learning.

Next, the device or person determines parameter values for implementing the trained model in the discretized circuit (Step S12).

Introducing the parameter β of the firing threshold scale into Equation (1), leads to Equation (7).

$$\begin{matrix}[ Equation 7 ] & \\ \frac{d}{dt} {v}_{i}^{( l )} ( t ) = β {\sum }_{j} {w}_{ij}^{( l )} θ ( t - {t}_{j}^{* ( l - 1 )} ) & ( 7 )\end{matrix}$$

In Equation (7), the parameter β plays the role of a coefficient that adjusts the rate of change of the membrane potential. By adjusting the value of parameter β, the speed at which the membrane potential vᵢ⁽¹⁾ reaches the firing threshold can be adjusted without the need to change the value of the weighting Wᵢⱼ⁽¹⁾.

The parameter β can be used as a parameter to adjust the scale of the membrane potential illustrated in FIG. 2. When designing the circuit model, the value of the parameter β can be set according to the firing threshold set for the spike generator.

For example, if a spike generator with a normalized firing threshold value of Vₜₕ=1 corresponds to 1 volt (V), while the firing threshold is set at 5 volts, the value of parameter β can be set to 5.

In the example in FIG. 2, the value of the voltage indicated by the vertical axis is scaled by a factor of 5 in response to the setting of β=5. This allows the voltage values to be consistent with the time without the need to change the time scale indicated by the horizontal axis and without the need to adjust the slope of the graph line by changing the value of the weighting wᵢⱼ⁽¹⁾.

Discretizing the weighting Wᵢⱼ⁽¹⁾ and the firing time tⱼ*⁽¹⁻¹⁾ for Equation (7) leads to Equation (8).

$$\begin{matrix}[ Equation 8 ] & \\ \frac{d}{dt} {v}_{i}^{( l )} ( t ) = β {w}^{( min )} {\sum }_{j} {w}_{ij}^{( level , l )} θ ( t - {t}_{j}^{( step , l - 1 )} Δ {t}^{( model )} ) & ( 8 )\end{matrix}$$

W^{(min)} indicates the weighting increment.

Wᵢⱼ^{(level,1)} denotes an integer that is multiplied by the weighting increment W^{(min)}.

W^{(min)}Wᵢⱼ^{(level,1)} denotes a rounded value by discretizing the weighting Wᵢⱼ⁽¹⁾ shown in Equation (7).

Δt^{(model)} indicates the incremental width of the firing time in the mathematical model.

tⱼ^{(step, 1-1)} indicates an integer that is multiplied by the firing time increment, λₜ^{(model)}.

tⱼ^{(step, 1-1)}ₜ^{(model)} denotes a rounded value by discretizing the firing time tⱼ*⁽¹⁻¹⁾ shown in Equation (7).

For Equation (8), a further scale transformation is performed to convert the time scale from the time scale in the mathematical model to the time scale in the circuit model. This scale transformation is shown in Equation (9).

$$\begin{matrix}[ Equation 9 ] & \\ t = \frac{Δ {t}^{( model )}}{Δ {t}^{( circuit )}} {t}^{′} & ( 9 )\end{matrix}$$

In Equation (9), time in the mathematical model is denoted as t, and the time in the circuit model is denoted as t′.

Δt^{(circuit)} denotes the firing time increment in the circuit model.

Applying Equation (9) to the relationship between Δt^{(model)} and Δt^{(circuit)}, Equation (10) is obtained.

$$\begin{matrix}[ Equation 10 ] & \\ Δ {t}^{( model )} = \frac{Δ {t}^{( model )}}{Δ {t}^{( circuit )}} Δ {t}^{( circuit )} & ( 10 )\end{matrix}$$

Using equations (9) and (10) to convert the time scale in Equation (8) from the time scale in the mathematical model to the time scale in the circuit model, Equation (11) is obtained.

$$\begin{matrix}[ Equation 11 ] & \\ \frac{d}{dt} {v}_{i}^{( l )} ( {t}^{′} ) = β {w}^{( min )} {\sum }_{j} {w}_{ij}^{( level , l )} θ ( \frac{Δ {t}^{( model )}}{Δ {t}^{( circuit )}} {t}^{′} - {t}_{j}^{( step , l - 1 )} \frac{Δ {t}^{( model )}}{Δ {t}^{( circuit )}} Δ {t}^{( circuit )} ) & ( 11 )\end{matrix}$$

In Equation (11), if “Δₜ^{(model)}/Δₜ^{(current)}” on the right side is factored out and put in front of Σ, and if “t” is rewritten as “t”, Equation (12) is obtained.

$$\begin{matrix}[ Equation 12 ] & \\ \frac{d}{dt} {v}_{i}^{( l )} ( t ) = β {w}^{( min )} \frac{Δ {t}^{( model )}}{Δ {t}^{( circuit )}} {\sum }_{j} {w}_{ij}^{( level , l )} θ ( t - {t}_{j}^{( step , l - 1 )} Δ {t}^{( circuit )} ) & ( 12 )\end{matrix}$$

Discretizing the current value Iᵢⱼ⁽¹⁾(t) and the firing time tⱼ*⁽¹⁻¹⁾ for Equation (4) leads to Equation (13).

$$\begin{matrix}[ Equation 13 ] & \\ C \frac{d}{dt} {v}_{i}^{( l )} ( t ) = {I}^{( min )} {\sum }_{j} {I}_{ij}^{( level , l )} θ ( t - {t}_{j}^{( step , l - 1 )} Δ {t}^{( circuit )} ) & ( 13 )\end{matrix}$$

I^{(min)} denotes the increment of the current value.

Iᵢⱼ^{(level,1)} denotes an integer that is multiplied by the current increment I^{(min)}.

I^{(min)}Iᵢⱼ^{(level,1)} denotes a rounded value by discretizing the current value Iᵢⱼ⁽¹⁾(t) shown in Equation (4).

The conditions for Equations (12) and (13) to be equivalent are considered. Substituting Equation (12) for “(d/dt)vᵢ⁽¹⁾(t)” in Equation (13) and expanding and arranging the individual terms before summing over j leads to Equation (14).

$$\begin{matrix}[ Equation 14 ] & \\ C β {w}^{( min )} \frac{Δ {t}^{( model )}}{Δ {t}^{( circuit )}} {w}_{ij}^{( level , l )} = {I}^{( min )} {I}_{ij}^{( level , l )} & ( 14 )\end{matrix}$$

Wᵢⱼ^{(level, 1)} and Iᵢⱼ^{(level, 1)} are both integers by discretization, and Wᵢⱼ^{(level, 1)}=Iᵢⱼ^{(level,1)}. The condition for Equation (14) to hold when Wᵢⱼ^{(level, 1)}=Iᵢⱼ^{(level, 1)} takes any integer value is expressed as in Equation (15).

$$\begin{matrix}[ Equation 15 ] & \\ Δ {t}^{( model )} {w}^{( min )} = \frac{Δ {t}^{( circuit )} {I}^{( min )}}{β C} & ( 15 )\end{matrix}$$

In Step S12 of FIG. 5, the device or person determines the value of each parameter to satisfy Equation (15). For example, the device or person may determine the parameter values so that the recognition performance and power efficiency of the spiking neural network is as high as possible under the constraints of Equation (15).

If the hardware specifications for implementing the spiking neuron model are fixed, the device or person may input the hardware specifications into Equation (15) to determine the parameter values for the discretization of the mathematical model.

For example, consider the case where the hardware specifications are determined as follows.

Current value increment: I^{(min)}=5 [nA]

Firing threshold: β=0.5 [V]

Capacitance of hidden layer capacitor: C^{(hidden)}=300 [fF]

Capacitance of the output layer capacitor: C^{(output)}=300 [fF]

The firing time increment: Δt^{(circuit)}=10 [ns]

In this case, entering the specification values into Equation (15) yields Equation (16).

$$\begin{matrix}[ Equation 16 ] & \\ Δ {t}^{( model )} {w}^{( min )} = \frac{Δ {t}^{( circuit )} {I}^{( min )}}{β C} = \frac{10 \cdot {10}^{- 9} \cdot 5 \cdot {10}^{- 9}}{0.5 \cdot 300 \cdot {10}^{- 15}} = 3.33 \cdot {10}^{- 4} & ( 16 )\end{matrix}$$

The device or person may determine the values of Δt^{(model)} and W^{(min)} that satisfy Δt^{(model)}W^{(min)}=3.33×10⁻⁴, in such a way that the recognition performance and power efficiency of the spiking neural network are as high as possible.

If the requirement specification is defined for the parameter values of the discretization of the mathematical model, the device or person may input the defined requirement specification into Equation (15) to determine the hardware specification to satisfy the conditions obtained. The parameter values of the discretization of the mathematical model are, for example, the value of Δt^{(model)} and the value of w^{(min)}. Hardware specifications are, for example, the value of I^{(min)}, the value of β, the value of C, and the value of Δt^{(circuit)}.

If the values of the parameters in Equation (15) are not determined for either of the mathematical model and the circuit model, the device or person may determine the parameter values for the discretization of the mathematical model based on the performance required of the spiking neural network, and input the determined parameter values into Equation (15) to determine the hardware specifications.

After Step S12 in FIG. 5, the device or person transforms the trained spiking neural network into a mathematical model with discretized weighting and firing times (Step S13). Specifically, the device or person replaces each of the spiking neuron models in the trained spiking neural network with a discretized model of spiking neurons to satisfy the Δt^{(model)} and w^{(min)} values obtained in Step S12. The connection relationships between spiking neuron models shall be the same as for the spiking neural network before the transformation.

Next, the device or person designs a circuit model of the spiking neural network by converting the mathematical model with discretized weighting and firing times into a circuit model with discretized current values and firing times (Step S14). Specifically, the device or person replaces each of the spiking neuron models in the mathematical model with discretized weighting and firing times with a spiking neuron circuit model to satisfy the values of I^{(min)}, β, C, and Δt^{(circuit)} obtained in Step S12. The connection relationships between spiking neuron models shall be the same as for the spiking neural network before the transformation.

After Step S14, the person or device completes the processing in FIG. 5.

After the process in FIG. 5, the device may automatically or semi-automatically generate a circuit model of the spiking neural network designed by the process in FIG. 5, thereby creating a hardware implementation of the trained spiking neural network. Alternatively, a person may use the device to generate a circuit model of the trained neural network designed by the process in FIG. 5, which is a hardware implementation of the trained spiking neural network.

As described above, at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model is determined such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

Using the parameter values obtained from this design method, a trained spiking neural network with an undiscretized firing time and weighting can be converted to a spiking neural network of a numerical model with a discretized firing time and weighting, and moreover to a spiking neural network of a circuit model in which the current value and weighting are discretized.

This design method provides relatively high accuracy in terms of training with spiking neural networks whose firing times and weightings are not discretized, and can also discretize the firing times in trained neural networks.

The firing time increment of the mathematical model and the weighting increment of the mathematical model are determined based on the specifications of the firing time increment of the spike generator, the minimum increment of the current value output by a synapse circuit, the firing threshold voltage of the spike generator, and the capacitance of the capacitor.

According to this design method, when the specification of the circuit model of a spiking neural network is fixed, the design parameter values of the mathematical model of the spiking neural network can be determined to be consistent with the specification of the circuit model of the spiking neural network.

The firing time increment of the spike generator, the minimum increment of the current value output by the synapse circuit, the firing threshold voltage in the spike generator, and the capacitance of the capacitor are determined based on the required specifications of the firing time increment of the mathematical model and the weighting increment of the mathematical model.

According to this design method, when the required specification for a spiking neural network based on a mathematical model with discretized firing times and weightings is fixed, the specification of the circuit model of a spiking neural network can be determined so as to be consistent with that required specification.

The design method further includes training a spiking neural network that uses a spiking neuron model in which neither of the firing time and weighting is discretized. The firing time increment in the mathematical model and the weighting increment in the mathematical model are design values for converting the trained spiking neural network that uses a spiking neuron model in which neither of the firing time and the weighting is discretized to a spiking neural network that uses a mathematical model of a spiking neuron in which the firing time and weighting are discretized. The aforementioned firing time increment of the spike generator, the minimum increment of the current value output by the synapse circuit, the firing threshold voltage of the spike generator, and the capacitance of the capacitor that simulates the membrane potential are design values for implementing the spiking neural network that uses a mathematical model of a spiking neuron in which the firing time and weighting are discretized in spiking neural network hardware that uses a circuit model of a spiking neuron in which the firing time and current value are discretized.

Using the parameter values obtained with this design method, a trained spiking neural network in which the firing time and weighting are not discretized can be converted to a spiking neural network based on a numerical model with a discretized firing time and weighting, and moreover to a spiking neural network based on a circuit model in which the current value and weighting are discretized.

This design method provides relatively high accuracy in terms of training with spiking neural networks whose firing times and weightings are not discretized, and can also discretize the firing times in trained neural networks.

FIG. 6 is a flowchart showing an example of the processing in the design method. The design method shown in FIG. 6 includes determining parameter values (Step S611).

In determining a parameter value (Step S611), at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model is determined such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

Using the parameter values obtained with the design method shown in FIG. 6, a trained spiking neural network in which the firing time and weighting are not discretized can be converted to a spiking neural network based on a numerical model with a discretized firing time and weighting, and moreover to a spiking neural network based on a circuit model in which the current value and weighting are discretized.

The design method shown in FIG. 6 provides relatively high accuracy in terms of training with spiking neural networks whose firing times and weightings are not discretized, and can also discretize the firing times in trained neural networks.

FIG. 7 is a schematic block diagram that illustrates the configuration of a computer according to at least one example embodiment.

In the configuration shown in FIG. 7, a computer 700 has a CPU (Central Processing Unit) 710, a main storage device 720, an auxiliary storage device 730, and an interface 740.

Any one or more of the processes in FIG. 5, and any one or more of the processes in FIG. 6, or parts thereof, may be executed by the computer 700. In that case, each of the above processes is stored in the auxiliary storage device 730 in the form of a program. The CPU 710 reads the program from the auxiliary storage device 730, deploys it in the main storage device 720, and executes the above processing according to the program. The CPU 710 also reserves a storage area in the main storage device 720 for the above-mentioned processing according to the program. Communication for the processes described above is performed by the interface 740, which has communication functions and communicates according to the control of the CPU 710. Interaction with the user for the processing described above is performed by the interface 740, which is equipped with a display and input devices, displaying various images and accepting user operations according to the control of the CPU 710.

When the processing in FIG. 5 is executed by the computer 700, each of steps S11 through S14 is stored in the auxiliary storage device 730 in the form of a program. The CPU 710 reads the program from the auxiliary storage device 730, deploys it in the main storage device 720, and executes the above processing according to the program.

The CPU 710 also reserves a storage area in the main storage device 720 for the processing of FIG. 5 according to the program.

When the processing in FIG. 6 is executed by the computer 700, the processing of Step S611 is stored in the auxiliary storage device 730 in the form of a program. The CPU 710 reads the program from the auxiliary storage device 730, deploys it in the main storage device 720, and executes the above processing according to the program.

The CPU 710 also reserves a storage area in the main storage device 720 for the processing of FIG. 6 according to the program.

A program for executing all or some of the processes in FIG. 5 and FIG. 6 may be recorded on a computer-readable recording medium, and a computer system may read and execute the program recorded on this recording medium to execute the processes of each part. The term “computer system” here shall include an operating system (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with a program already recorded in the computer system.

Although the above example embodiments of this invention have been described in detail with reference to the drawings, specific configurations are not limited to these example embodiments, with designs and the like also included to the extent that they do not depart from the gist of this invention.

### INDUSTRIAL APPLICABILITY

The present invention may be applied to a design method and a recording medium.

### DESCRIPTION OF REFERENCE SIGNS

700 Computer
710 CPU
720 Main storage device
730 Auxiliary storage device
740 Interface

What is claimed is:

1. A design method comprising:
determining at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.

2. The design method according to claim 1, comprising:
determining the firing time increment of the mathematical model and the weighting increment of the mathematical model based on the specifications of the firing time increment of the spike generator, the minimum increment of the current value output by a synapse circuit, the firing threshold voltage of the spike generator, and the capacitance of the capacitor.

3. The design method according to claim 1, comprising:
determining the firing time increment of the spike generator, the minimum increment of the current value output by the synapse circuit, the firing threshold voltage in the spike generator, and the capacitance of the capacitor based on the required specifications of the firing time increment of the mathematical model and the weighting increment of the mathematical model.

4. The design method according to claim 1, further comprising training a spiking neural network that uses a spiking neuron model in which neither of the firing time and the weighting is discretized,
wherein the firing time increment in the mathematical model and the weighting increment in the mathematical model are design values for converting the trained spiking neural network that uses a spiking neuron model in which neither of the firing time and the weighting is discretized to a spiking neural network that uses a mathematical model of a spiking neuron in which the firing time and weighting are discretized, and
the firing time increment of the spike generator, the minimum increment of the current value output by the synapse circuit, the firing threshold voltage of the spike generator, and the capacitance of the capacitor that simulates the membrane potential are design values for implementing the spiking neural network that uses a mathematical model of a spiking neuron in which the firing time and weighting are discretized in spiking neural network hardware that uses a circuit model of a spiking neuron in which the firing time and current value are discretized.

5. A non-transitory recording medium that records a program for causing a computer to
determine at least one of a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model such that the product of the firing time increment of the mathematical model and the weighting increment of the mathematical model is equal to a value obtained by dividing the product of the firing time increment of the spike generator and the minimum increment of the current value output by the synapse circuit by the product of the firing threshold voltage of the spike generator and the capacitance of the capacitor.
